(19) United States
(12) Patent Application Publication
(10) Pub. No.: US 2002/0107720 A1
(43) Pub. Date: Aug. 8, 2002

(54) Automated system and method of forecasting demand

(75) Inventor: Ernest Martin, Orlando, FL (US)

Correspondence Address: OPPENHEIMER WOLFF & DONNELLY LLP, 38th Floor, 2029 Century Park East, Los Angeles, CA, 90067-3024, US

(73) Assignee: WALT DISNEY PARKS AND RESORTS

(21) Appl. No.: 09/947,262

(22) Filed: Sep. 5, 2001

Related U.S. Application Data
(60) Provisional application No. 60/230,582, filed on Sep. 5, 2000.
(60) Provisional application No. 60/230,036, filed on Sep. 5, 2000.

(51) Int. Cl. G06F 17/60

(52) U.S. Cl. 705/10

(57) ABSTRACT

The present invention provides a system and method for producing guest demand forecasts that keep pace with the dynamic nature of an amusement park's operating environment, and are prepared in a statistically valid and efficient manner. The invention improves upon prior art processes by creating dynamic workload calculations that are responsive to business changes and require minimal effort to update.

### RELATED APPLICATIONS

This application claims the filing date benefit of U.S. Provisional Patent Application No. 60/230,582, filed Sep. 5, 2000, entitled Location Level Forecasting, and of U.S. Provisional Patent Application No. 60/230,036, filed Sep. 5, 2000 entitled Cast Deployment System and is related to U.S. Patent Application No. ______ (Attorney Docket 20433-14) entitled System and Method of Real Time Deployment, filed contemporaneously with this application, the contents of which are incorporated herein.

### BACKGROUND OF THE INVENTION

1. Field of the Invention

The invention relates generally to forecasting. More particularly the invention relates to forecasting demand and workload for operational venues such as amusement or theme parks.

2. General Background and State of the Art

Amusement and theme parks first started out as rather small operations with only a few rides or attractions. These days, amusement parks are a huge commercial success. Each year, 300 million people visit amusement parks in the United States. The most popular amusement parks receive and average of 10 to 15 million visitors each year. These parks now span hundreds of acres and staff thousands of people in order to sustain operations every day. Effectively operating a business of this size is a formidable task. Therefore, new methods of effectively organizing and running operations on a day to day basis are always desired.

The sheer size of modern day amusement parks presents a challenge to those in charge of everyday operations. A huge number of employees are required to staff the park and the number of visitors that visit each day. The number of visitors can range from 10,000 people to 75,000 people per day. Also, there can be a great difference in the number of visitors to the park throughout the period of a day. Since the number of visitors to the park may vary from time to time, more or less staff may be required to support the varying visitor volume. In a theme park environment, if workload is understated, a business area may be understaffed to meet guests' needs and guest service levels are not met. If workload is overstated, more employees are scheduled than are needed, which can lead to unproductive time or early releasing employees. Additionally, sudden changes in visitor patterns or volume may make it necessary to shift and share staff resources between various areas of the park.

True Work Requirements (TWR) was an earlier spreadsheet based single regression statistical tool used to calculate forecasts. Industrial Engineers would conduct lengthy studies in locations to derive a workload forecast. This statistical model produced a single, static workload forecast and only considered variable labor positions. The TWR model was not responsive to business changes, and, over time, became stale and outdated. The labor required to continually revisit locations to update workload did not exist. Once models became stale, business areas stopped using the models.

Accordingly, it is an object of the present invention to provide operations areas with a way to dynamically foresee workload requirements by using historical data and multiple business drivers that are pertinent to their line of business.

### INVENTION SUMMARY

These and other objects are achieved by the present invention, which provides a system and method for producing guest demand forecasts that keep pace with the dynamic nature of an amusement park's operating environment, and are prepared in a statistically valid and efficient manner. The invention improves upon prior art processes by creating dynamic workload calculations that are responsive to business changes and require minimal effort to update.

The system and method of the present invention uses selected historical data to generate demand forecasts for each business or operating area in a park. For example, each shop, restaurant, or ride attraction may be considered a separate business or operating area. Data is collected from each of the operating areas and recorded in a database. A statistical model is used to analyze the data and generate a demand forecast and translates this into workload in specified time increments. It then creates an export file which can then be used by a scheduling system or application to derive schedules for the staff.

The system and method of the present invention utilizes state of the art statistical techniques to project total daily guest demand based on its historical relationship to multiple business drivers. The total daily forecast will then be distributed across the day based on historical patterns. To address the complexity of a park's operating environment, the tool provides multiple analytical techniques and the flexibility to select relevant local business drivers. The system allows users to develop and execute models in a highly automated fashion and provides routine feedback on model performance. It is scalable to accommodate expected business growth and the addition of new data elements. Finally, the system is designed to interface with a scheduling system and a planned day-of staff deployment tool.

The proposed system will enable the preparation of demand forecasts for a variety of locations throughout the park. Among the disciplines the system supports include attractions, food, merchandise, main entrance, and hotel operations.

This application is unique in that it couples the functionality of calculating demand forecasts based on multiple demand drivers with that creating workload for the service industry in one program. Providing an accurate portrayal of guest demand is viewed as an analytical cornerstone in the initiative to reduce operation costs. More efficient deployment of reduces the cost of guest service delivery while at the same time satisfying work preferences, for example, providing more flexible work schedules. The present invention is expected to also positively impact guest service, staff satisfaction, and financial results.

The system and method of the present invention helps to ensure that the right staff person is put “in the right place at the right time”, and is therefore expected to drive positive guest perception through improved service levels. By developing schedules that more accurately match guest demand, the staff is positively impacted by helping to ensure a more defined workload. The forecasting system and method of the present invention should enhance the ability to offer scheduling options that better meet the needs of the staff. Financial benefits will be derived from the ability to better manage variable costs. For example, an overall reduction in labor expense due to an improved alignment of staff with guest demand is anticipated. The forecasting system is expected to deliver benefits of $400K-$450K annually driven by improved forecast accuracy.

### BRIEF DESCRIPTION OF THE DRAWINGS

FIG. 1 is a high level perspective of the prior art forecasting method.

FIG. 2 is a high level perspective of the forecasting method of the presenting invention.

FIG. 3 is a flow chart detailing the process of creating a forecast model for total daily demand.

FIG. 4 is a flow chart detailing the process of generating the total daily demand forecast based upon the model developed in FIG. 3.

FIG. 5 is a flow chart detailing the process of creating models that will be used in the distribution of forecasted daily demand into segments throughout the day.

FIG. 6 is a flow chart of the process of generating forecasts based on the model created in FIG. 5.

FIG. 7 is a screen shot of an exemplary embodiment of the main document interface of the present invention.

FIG. 8 is a screen shot of an exemplary embodiment of volume model editor interface of the present invention.

FIG. 9 is a screen shot of an exemplary embodiment of the distribution model editor interface of the present invention.

### DETAILED DESCRIPTION OF THE EXEMPLARY EMBODIMENTS

The forecasting system and method of the present invention is designed for use in amusement or theme parks to more accurately predict guest demand. The present invention employs state of the art statistical techniques and multiple business drivers to analyze selected historical data and thereby create forecasts for each operating area or location in the park. In addition to improving service level, guest perception, and overall efficiency, employee satisfaction is expected to be impacted through the use of the present invention.

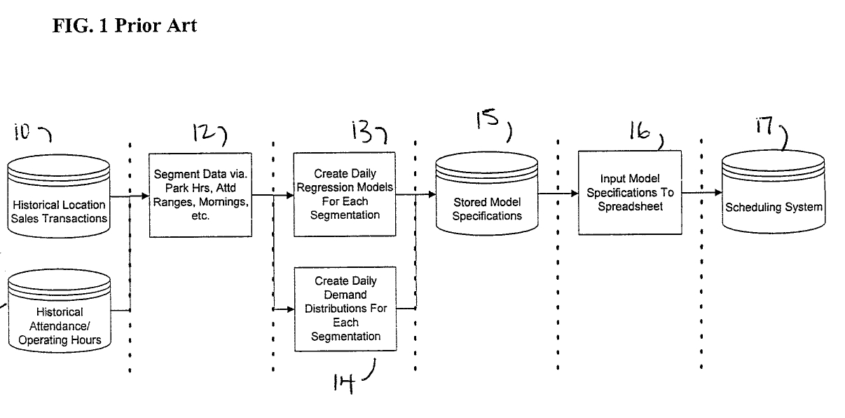

Turning to FIG. 1, the prior art method of forecasting demand as was used in the past and mentioned above is illustrated. Historical data was previously taken from two major categories: sales transactions 10 and attendance 11. By way of definition, historical data is information that is reflective of what has occurred in the past. As an example, the number of point of sale transactions that occurred at a cash register in the Emporium between 12:00 and 12:15 on Jun. 30, 1999 is considered historical information. Sales transactions include transactions recorded at all locations throughout the park such as food vendors and souvenir shops. Attendance is recorded from ticket sales. The two sources of data were then segmented according to park hours and the desired date range in step 12. Daily regression models were then created for each segmentation, and daily demand distributions created for each segmentation in steps 13 and 14 respectively. These models were stored so that they may be available for later use. The model specifications were manually input into a spreadsheet. Finally, as shown in block 17, the models could be sent to a scheduling program.

There are several weaknesses in this prior art method of forecasting demand. The method by which historical data required for making forecasts is collected is unorganized and inconsistent. The data comes from a number of disparate data sources and there are inconsistencies amongst data definitions and formats. Data collections must be updated manually, and there is no option to define hierarchies among data. Secondly, the methods by which daily regression models were created are inconsistent and limited in their analytical options. Models are based on only a limited number of business drivers, and only minimal number of specifications may be defined. Finally, once regression models have been created, there is no ability to dynamically adjust forecast results. The prior art method uses a spreadsheet format and requires manual operation and entry of much of the data. The overall process is manually intensive and inefficient.

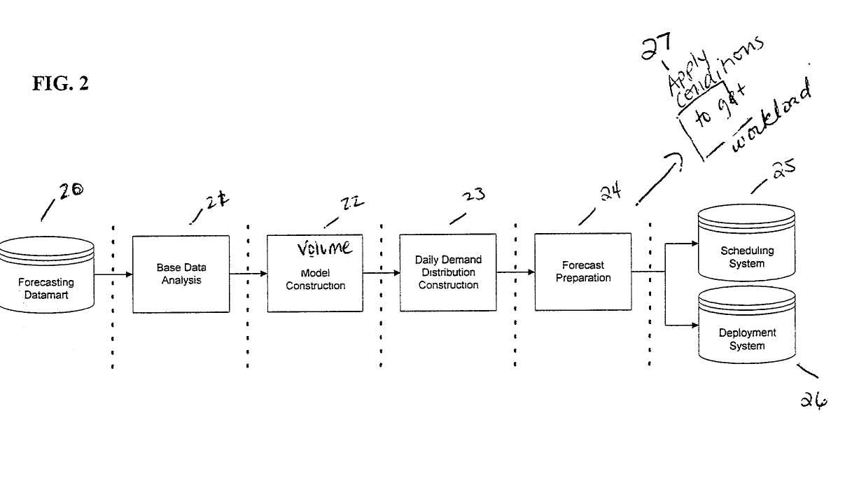

FIG. 2 illustrates an exemplary embodiment of the forecasting method of the present invention. A forecasting datamart 20 is introduced as a single source for obtaining and storing all historical data used in the forecasting process. The datamart consists of a database which acts as storage means for data. In addition, the datamart collects historical data by accepting feeds from the numerous data sources located throughout the park. The data is of various formats as mentioned in the prior art method. The datamart further provides functionality to deliver this data in one consistent and easy to use manner. The datamart recognizes different formats of data from different sources and works to store data in a single consistent format. Issues with inconsistencies in data definitions have been resolved with the introduction of the datamart. The datamart 20 has been designed to provide user-friendly access to information. Data is updated automatically by the datamart and data access is an integrated system component, as well.

The datamart also provides storage for other critical operational data which is necessary to the forecasting process. For example, scheduled data, or information that deals with future events that have a predetermined schedule and that will occur with a high degree of certainty, is recorded by the datamart. The performance times of the Festival of the Lion King are considered scheduled information, and must be taken into consideration when generating accurate forecasts. Forecasted data, or information that has been projected for a future date, is also recorded by the datamart. As an example, if today is Feb. 20, 2000, the estimated attendance at the Magic Kingdom on Mar. 1, 2000 is considered forecasted information. Guest count, population, occupancy, arrivals, departures, temperatures, etc. are all types of data that are held by the datamart, and my be scheduled, forecasted or actual data. For example, the number of transactions that occur at a given register at an food and beverage, merchandise, or other sales location for a specified time period on a specified date is recorded as the point of sale transaction count. Item count similarly represents the number of items in specific categories that are sold at a given location for a specified time period on a specified date. Guest count represents the number of guests that have passed through the turnstiles for an attraction or a theme park during a specified time period on a specified date. Population represents the total number of guests staying at a resort for a specified date. Occupancy represents the total number of rooms occupied by guests for a specified date. Arrivals represents the number of guests who check in at a resort during a specified time period on a specified date. Departures represents the number of guests who check out from a resort during a specified time period on a specified date. Temperatures (high and low) represents the high or low temperature recorded at a weather station during a specified time period on a specified date. Rainfall represents the amount of rainfall recorded at a weather station for a specified time period on a specified date. Park hours and operating hours for a location within a gated attraction or resort is another type of data used in the forecasting process.

The success of accurate forecasting is dependent upon the ability to examine past historical patterns of guest demand and its relationship to causal factors. Due to the nature of these forecasts and the methodology used to create them, the system must be able to store large amounts of data. The ability to store several years worth of such historical data is necessary to the present invention. However, once data becomes a certain age, the trends inherit to the data may no longer apply due the evolving business environment; therefore, there is limited need for offline storage of old data. Besides historical data such as ticket sales , data such as arrivals, departures, occupancy, population, attendance, crossovers, and re-entries must be recorded as well.

Also shown in FIG. 2 is the data analysis step 21 of the present invention in which data from the datamart can be modified, flagged, or cleansed before it is used to create a forecast model. In this step, a robust statistical and graphical output is used to aid in analysis of the data. The system can be set to automatically cleanse anomalous data, or a user may modify data or flag it for exclusion from a subsequent analysis without deleting data from the datamart. However, for the most part, no automated processes are used for the data analysis step as the criteria for identifying outlier data is so often highly situational and as such very difficult to fully describe in an automated context. Instead, scatter and adequacy of fit plots are used to manually pick out and exclude anomalous data. As stated, these points are flagged in the database rather than deleted, so they may be reinstated later if the situation changes and these points are no longer considered outliers. Until the flagged data points are manually reincluded they are automatically withheld from all subsequent analyses and calcuations within the context of the current forecast model entity.

Once data has been cleansed, it is ready to be analyzed using known statistical techniques. The present invention makes available a full suite of statistical analysis tools with which data can be analyzed. Each technique uses a different set of business drivers. A statistical analysis technique may be thought of as a particular mathematical algorithm. The different variables which define the algorithm may be thought of as the business drivers. By way of definition, business drivers are defined as any daily quantity or condition which is known or for which an established forecast exists sufficiently in advance that it can be used as a predictor for guest demand at a location. To be particularly useful, a business driver should also have some strong consistent relationship or correlation to guest demand that can be expected to remain consistent and predictable from the time of forecasting through the point of day of deployment. Common examples of business drivers include daily park attendance, resort occupancy, arrivals, & departures, operating hours, seasonality conditions, special events, etc.

In the step shown at block 22 of the forecasting method shown in FIG. 2, a total daily demand, or volume model is constructed. The process uses well developed analytical techniques and appropriate business drivers to model local conditions. A full suite of statistical analysis techniques is available as well as a number of business drivers. Once an algorithm is chosen, drivers relevant to the location are selected and applied to the data. Graphical and statistical output is used to enable the analysis of the potential drivers. The system is designed to support multiple skill levels, including an automated model construction. To help aid in proper driver selection, the process is iterative. Multiple smoothing and normalization techniques may also be utilized in coming up with the best distribution model. The present invention can create and store multiple location models.

In addition to the model for total daily demand, a distribution model is created as shown in step 23 to determine demand in small segments throughout the day. The purpose of the distribution model is to examine the relationship between business drivers or operating conditions and the typical daily allocation of demand in small time intervals. A daily demand distribution construction is created by applying business drivers relevant for the location to the data. Graphical and statistical output is used to enable the analysis of the potential drivers. To help aid in proper driver selection, the process is iterative. Multiple smoothing and normalization techniques may also be utilized in coming up with the best distribution model.

Once volume and distribution models have been constructed, forecasts are executed. Forecasts are executed by applying the previously generated volume and distribution models to data. The result is a total daily demand or volume forecast and a daily distribution forecast. The volume forecast generally provides the projected total number of visitors for a day. The volume forecast can be generated for any date or date range. The results are usually shown in graphical output, plotted as total number of visitors forecasted vs. date. The distribution forecast is similarly output in graphical format, usually plotted as percentage of the total number of visitors forecasted for that day vs. time of day. The present invention provides the functionality for forecasts to be executed in an automatic/batch mode. The system and method of the present invention ensures that executing forecasts allow for manual adjustment as well so that the forecasts are as accurate as possible.

Once a satisfactory forecast is developed for both the total day and daily distribution the two are combined to produce a demand forecast for each individual segment of the day. This result can then either be fed directly to a scheduling system, or more often then becomes the input to a workload calculation to determine labor needs for each of these periods. The forecasts may be exported to other applications for further analysis of the data. Forecasted data is generally used by a scheduling and deployment system. The scheduling system uses the demand forecast to create future schedules for employees. The deployment system receives these schedules and manages employees on the day of to ensure demand is being met efficiently.

Demand forecasts may be converted into workload requirements before or after being exported to the scheduling or deployment system. In this process, a measured labor standard (capacity) and guest service standard (timeliness plus any non-demand-driven guest interaction requirements) are applied to the demand forecast for each specific job type within the operating area to produce a requirement for each period that is the number of employees needed in order to properly serve that demand.

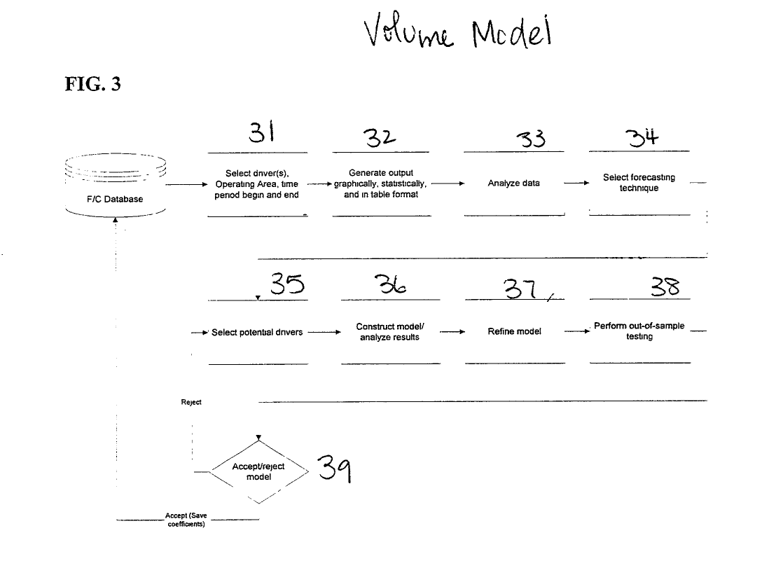

Turning, to FIG. 3, the process of creating a forecast model for total daily demand is illustrated in more detail. The model for total daily demand is based upon historical business driver data and will be used for future forecasts for the location specified in the model. First, shown at block 31, the operating area and time period begin and end for which the model is to be created must be entered. In the next step of creating a forecast model labeled 33, a technique or algorithm must be selected with which to analyze the data. The present invention offers a suite of different analytical techniques (e.g. time series, linear regression, general regression, smoothing, etc.) that can be selected from and used to develop a daily forecast model. In an exemplary embodiment of the present invention, the best suited elements of these techniques have been incorporated into a single multiple regression algorithm, allowing ease of use for the user. The user then selects drivers relevant to the business location at step 35. A model is constructed based on the drivers selected in step 36. Results of the model are plotted in a window for the user to view in step 37. The results of the model may be plotted along with actual and fitted data so that the user can asses the success of the model generated. The model is refined in step 38 by repeating the process until the desired model is achieved. The user then chooses to accept and save the model as shown at block 39 in the drawing.

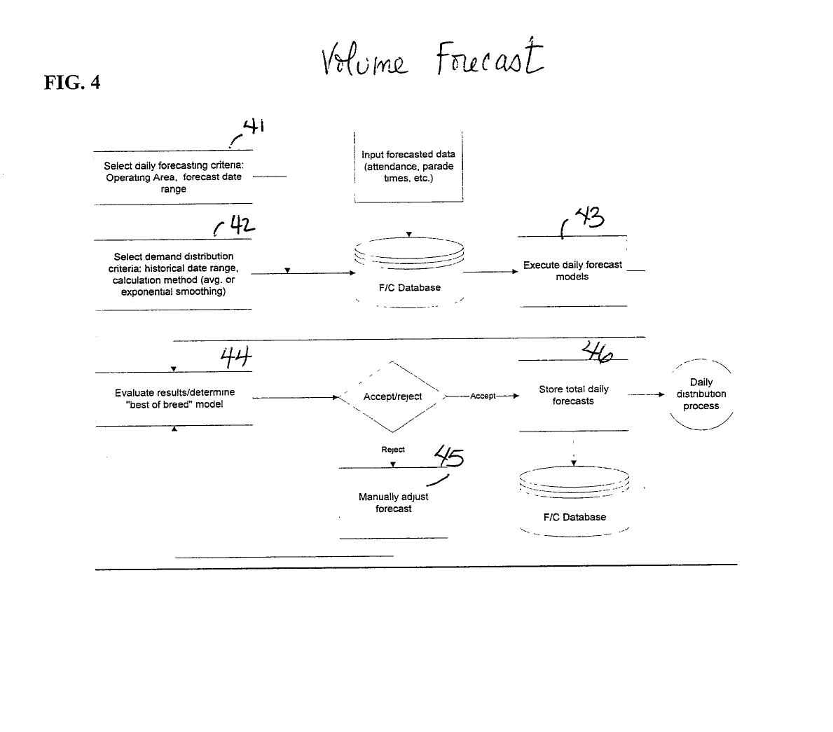

FIG. 4 is a flow chart detailing the process of generating the total daily demand forecast based upon the model developed in FIG. 3. The forecast execution process consists querying the database for the forecast or scheduled driver values for a selected operating area and time frame, retrieving the previously stored model information created for that area, and then evaluating the model using the queried driver information as its inputs. As stated, this candidate forecast is then analyzed graphically and statistically to determine its adequacy. If it is deemed appropriate, it is kept and exported to the next step in the process. Otherwise, it is set aside and the analyst will have the opportunity to go back and choose a different model and try again, or manually override the result if necessary. As shown at block 41, the user must first select criteria such as the operating area and date range for which the forecast is to be made executed. The total daily demand model as was saved in the database in the datamart is retrieved and applied to data. Once the forecast has been executed, the results are viewed in graphical format and evaluated. If the forecast is considered acceptable, it is stored in the database. If the forecast is not considered acceptable, the process may be repeated. The system and method of the present invention ensures that executing forecasts allow for manual adjustment so that the forecasts are as accurate as possible.

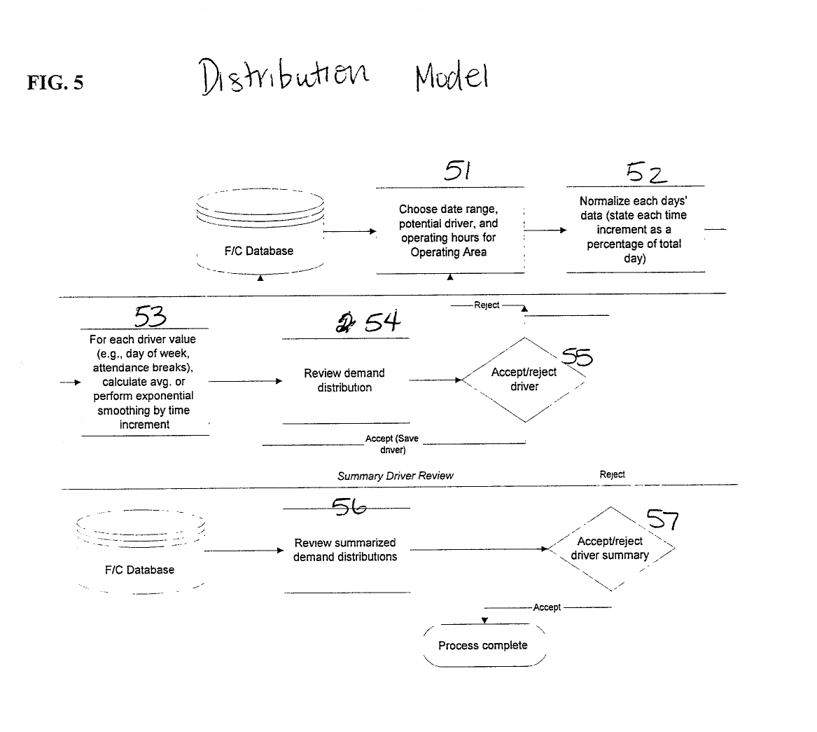

FIG. 5 is a flow chart detailing the process of creating a model that will be used in distributing forecasted daily demand throughout the day. The purpose of the distribution model is to examine the relationship between business drivers or operating conditions and the typical daily allocation of demand in fifteen minute intervals. It does this by grouping days into partitions according to the different scenarios defined by the business drivers selected. For example, if park opening and closing times are chosen as drivers, a different partition will be created for each combination of open and close which occurred within the selected historical period. For each of these partitions, the historical demand will be normalized into percentages of total day demand for each fifteen minute period, and then these percentages are aggregated (averaged or smoothed) across the days in the partition to develop a representative daily demand profile estimate for each partition. These profiles are then iteratively analyzed individually and compared with each other graphically to develop an optimal model. This consists primarily of two steps; first, examining confidence intervals around each fifteen minute period's capture estimate within an individual profile to ensure that the drivers have successfully reduced the data down to a group of consistent or homogenous days (with all outliers removed); and second, comparing the charted profiles and upper and lower confidence curves to verify that the various partitions are in fact distinct and optimally separated by the selected drivers.

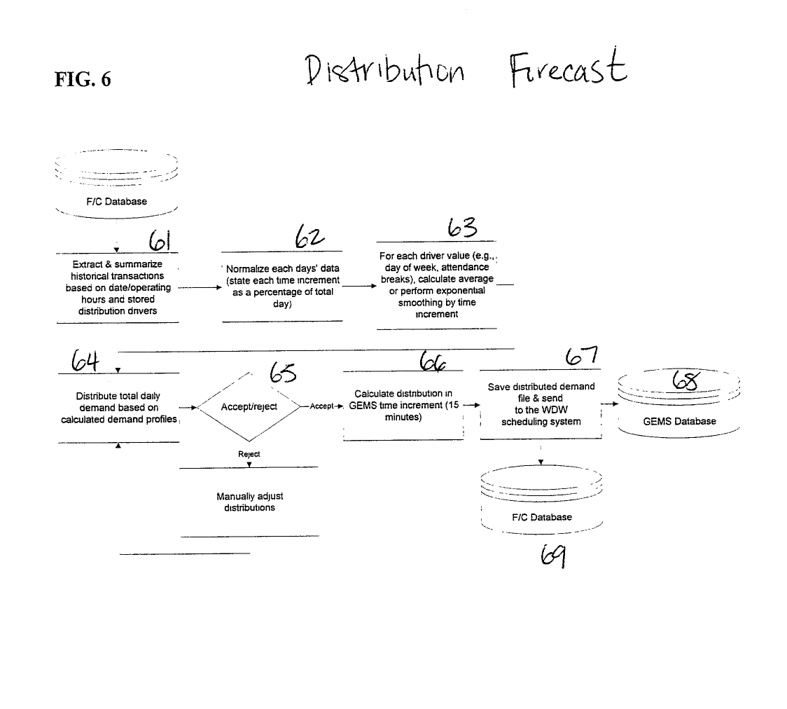

FIG. 6 is a flow chart of the process of generating distribution forecasts based on the model created in FIG. 5. Historical data is first retrieved from the database and summarized based on criteria such as date, operating hours and stored distribution drivers. The data is then normalized such that each time increment is stated as a percentage of the total daily demand. For each driver value, the average is calculated or exponential smoothing is performed by time increment. The total daily demand is then distributed based on calculated demand profiles. If the forecast is accepted, it is then stored in the database. A distribution in small time increments is then calculated, saved, and sent to the scheduling system.

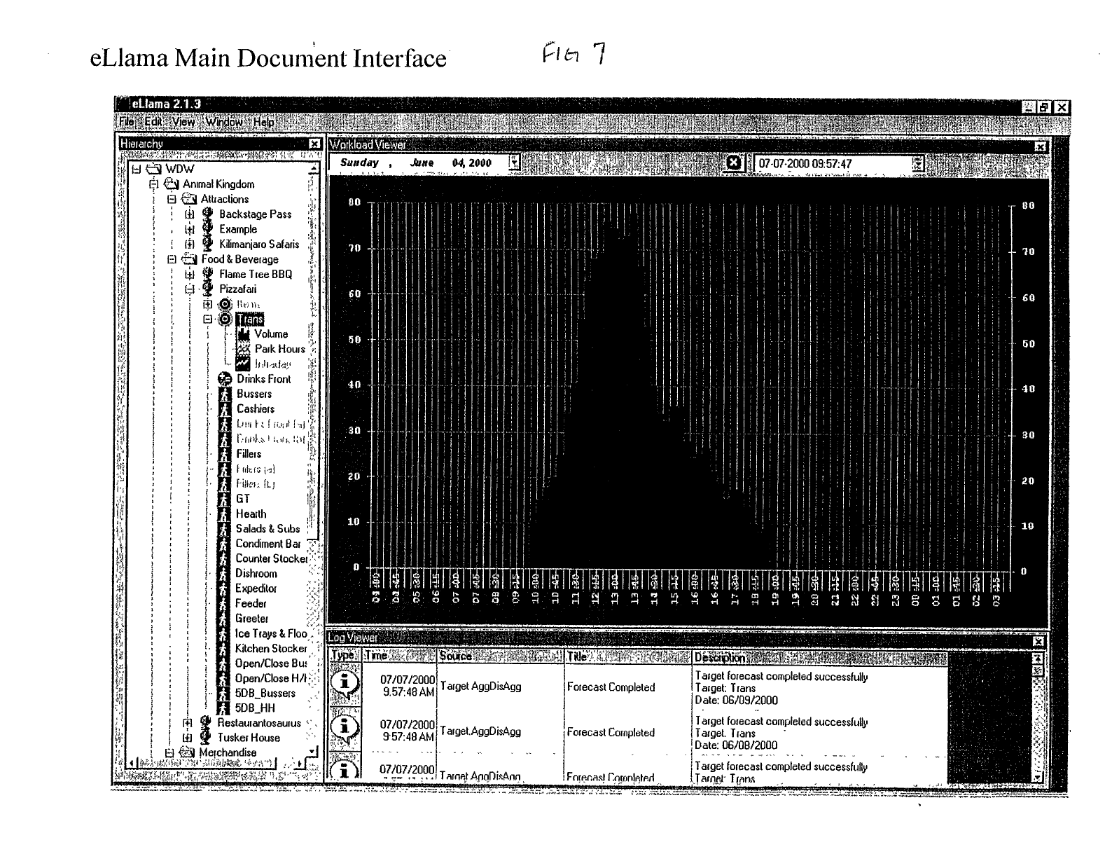

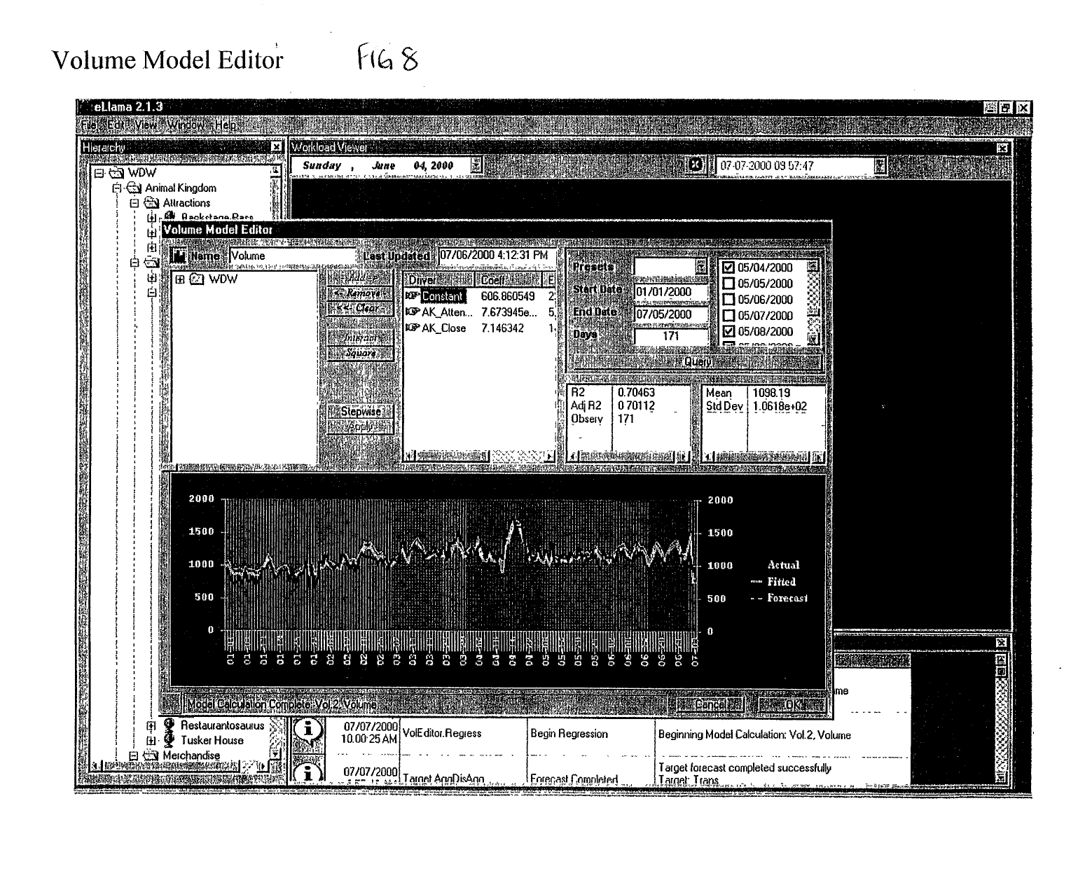

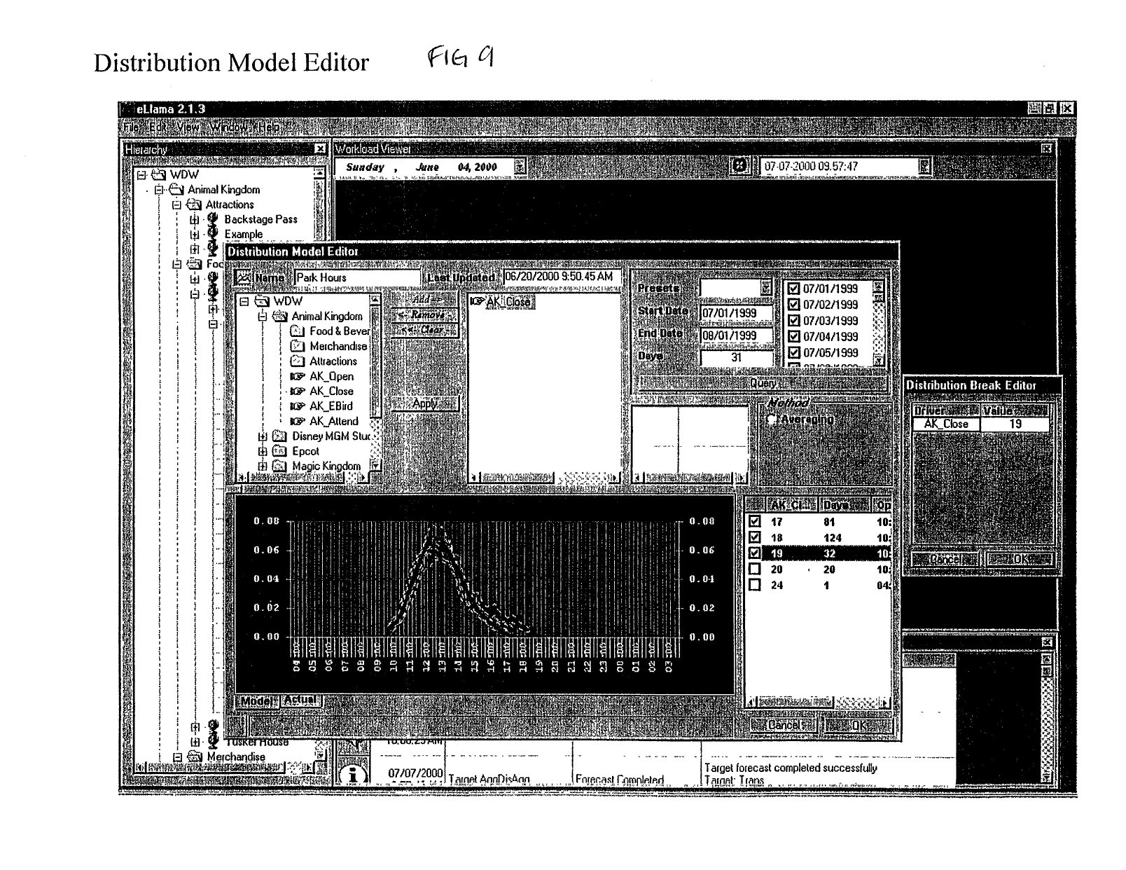

FIG. 7 is a screen shot of an exemplary embodiment of the main document interface of the present invention. Main screen 70 displays a distribution forecast for the date shown in the drop down box at 71. There is a log window 72 below the main window 70 where log messages 73 are displayed. The log message display the operations that have been performed with time and description. On the left hand side of the user interface screen is the hierarchy window which displays all the operating areas available for forecasting. Turning to FIG. 8, a screen shot of an exemplary embodiment of the present invention displaying part of the process of creating a forecast model for total daily demand is shown. In the screen entitled “Volume Model Editor” operating area or location is specified in window 82 and drivers to be applied to the data are selected in window 84. Date and time information is also entered. Results of the model calculation is output on the screen in a graphical format along with actual and fitted data. An exemplary embodiment of the distribution model editor is additionally shown in FIG. 9.

Exemplary embodiments of the system and method of the present invention include generation of several reports which detail and analyze the performance of the models and forecasts created. A report of the daily demand forecast vs. actual performance, for example, is useful in determining how successful a particular forecast model has been. This report compares forecasted daily demand for a series of dates against the actual daily demand for a given location or hierarchy level. It calculates the variance, or the difference between the actual demand and the forecasted demand, for each date and statistical error data for the range of dates. It is presented to the user in tabular form and as a graph. If in graph form, the user is be able to specify viewing the literal demand (forecasted and actual) in overlay fashion or just the calculated variance. The mean absolute percent error for the range of dates is calculated by summing the absolute values of the daily percentage variance and dividing by the number of days in the range. The Coefficient of Variation for the range of dates is also calculated by taking the standard deviation of the error and dividing by the average demand for the date range.

Similar to the above report is the daily demand distribution forecast vs. actual, which displays in either tabular form or as a graph as selected by the user, the values of the daily demand distribution forecast versus the actual demand distribution experienced by the location. The value of time period for which the data represents (e.g., 10:15 a.m.) is shown. This could be in a variety of time increments depending on the type of demand being compared. A statistical comparison, or measurement that would indicate the degree of accuracy achieved with the forecast, e.g., upper and lower confidence levels, standard deviation is calculated.

Demand of a particular park location can be compared to that of another location in the park by viewing the daily demand location comparison report. This report allows the user to graphically, or in tabular form, view a location's daily demand for a user-specified date range and overlay it with another location's daily demand. It would be used to compare the demand of locations that are related to one another. Similarly, a user may view daily demand distribution location comparison which allows the user to graphically, or in tabular form, view a location's daily demand distribution for a user-specified date range and overlay it with another location's daily demand distribution. It would be used to compare the demand of locations that are expected to be similar to one another.

The present invention was designed with the idea of an amusement and theme park environment in mind. However, the present invention should not be limited to this particular application only. The system and method of the present invention can be easily applied to a wide variety of business models. For example, it is anticipated to be within the scope of the present invention to apply the system and method of the present invention for use in productivity & process improvement, labor management, merchandise operations, food & beverage operations, or hotel and resort operations. For example, the invention could be used to forecast demand and workload for retail stores, shopping malls, restaurants, hotels, etc. While the specification describes particular embodiments of the present invention, those of ordinary skill can devise variations of the present invention without departing from the inventive concept.

In closing it is to be understood that the embodiments of the invention disclosed herein are illustrative of the principals of the invention. Other modifications may be employed which are within the scope of the invention. Accordingly, the present invention is not limited to that precisely as shown and described in the present specification.

We claim:

1. An automated method of forecasting demand for a business location, the method comprising the steps of:
a) automatically obtaining and recording historical data relevant to the business location;
b) analyzing said historical data to eliminate any unwanted data points;
c) creating a forecast model by choosing at least one statistical analysis technique and at least one business driver relating said business location to the historical data;
d) applying the forecast model to selected data; and
e) generating a demand forecast.

2. The method of claim 1 wherein historical data includes past attendance and historical location sales transactions.

3. An automated method of forecasting demand for a business location, the method comprising the steps of:
a) automatically obtaining and recording historical data relevant to the business location;
b) analyzing said historical data to eliminate any unwanted data points;
c) creating a total daily demand/volume forecast model by choosing at least one statistical analysis technique and at least one business driver relating said business location to the historical data and applying to the historical data;
d) creating a daily distribution forecast model by choosing at least one statistical analysis technique and at least one business driver relating the business location to the historical data and applying to said historical data;
e) generating a total daily demand forecast using said forecast total daily demand forecast model; and
f) generating a daily distribution forecast using said daily distribution forecast model.

4. The method of claim 3 wherein historical data includes past attendance and historical location sales transactions.

5. The method of claim 3 wherein eliminating unwanted data points is done by flagging data for exclusion.

6. The method of claim 3 further including the step of exporting the total daily demand forecast and daily distribution forecast for use in a scheduling system.

7. An automated method of forecasting demand for a business location, the method comprising the steps of:
a) automatically obtaining historical data relevant to said business location;
b) selecting business drivers relevant to said business location;
c) applying statistical analysis techniques using the selected business drivers to the historical data to create a forecast model;
d) storing the forecast model in a database;
e) querying a database for driver values for a selected operating area and time period;
f) retrieving the previously stored model information created for said business location; and
g) evaluating the model using the queried driver values as its input.

8. The method of claim 7 wherein said time period is a day.

9. The method of claim 7 wherein the smaller time segment is about fifteen minutes.

10. The method of claim 7 wherein the smaller time segment is about thirty minutes.

11. An automated method of forecasting demand for a business location, the method comprising the steps of:
a) automatically obtaining historical data relevant to said business location;
b) selecting business drivers relevant to said business location;
c) applying statistical analysis techniques using the selected business drivers to the historical data to create a forecast model;
d) storing the forecast model in a database;
e) querying a database for driver values for a selected operating area and time period;
f) retrieving the previously stored model information created for said business location;
g) evaluating the model using the queried driver values as its input.
h) distributing said forecast of total demand into smaller time segments corresponding to the workday;
i) normalizing the data for each smaller time segment; and
j) displaying the results of the forecast in a graphical format.

12. The method of claim 10 wherein said time period is a day.

13. The method of claim 10 wherein the smaller time segment is about fifteen minutes.

14. An automated system for forecasting demand, the system comprising:
a) automated means for collecting data from different business locations;
b) at least one database for storing the collected data;
c) a user interface for accepting specifications from a user.
d) processing means for performing statistical analysis techniques on data;
e) at least one database for storing forecast models; and
f) display means for displaying forecast results.

15. The automated system of claim 14 wherein display means is a computer monitor.

16. The automated system of claim 14 wherein user interface is a personal computer and keyboard.

17. The automated system of claim 14 wherein means for collecting data from different business locations includes a computer network whereby data is communicated from business locations to a central location.

18. The automated system of claim 14 wherein processing means is a server.

19. An automated method of forecasting demand and workload for a business location, the method comprising the steps of:
a) automatically obtaining and recording historical data relevant to the business location;
b) cleansing said historical data of outlier data;
b) creating a forecast model by choosing at least one statistical analysis technique and at least one business driver relating the business location to the historical data and applying to said historical data;
c) generating a demand forecast using the forecast model; and
d) translating the demand stated by the forecast into workload requirements.
